(19) United States
(12) Patent Application Publication
(10) Pub. No.: US 2025/0328526 A1
(43) Pub. Date: Oct. 23, 2025

(54) Optimized Query Of Table With No Index For Table Comparison In Heterogeneous Source And Target Databases

(71) Applicant: Oracle International Corporation, Redwood Shores, CA (US)

(72) Inventors: Arnab Nandi, Dublin, CA (US); Scott Roger Corbin, Spooner, WI (US); Jonathan Fu, Pleasanton, CA (US)

(21) Appl. No.: 18/639,344

(22) Filed: Apr. 18, 2024

(51) Int. Cl. G06F 16/2453

(52) U.S. Cl. CPC G06F 16/24537

(57) ABSTRACT

A database comparison tool is provided that compares a source database to a target database. The database comparison tool performs the comparison in two steps: an initial comparison step and a confirmation step. In the initial comparison step, a server retrieves rows of a table from source and target database tables with a query using an agent. The server compares rows by using a hash value for all non-key columns. The resulting rows are flagged as potentially being out-of-sync. In the confirmation step, the server fetches the potentially out-of-sync rows from the source and target databases and performs a literal value-by-value comparison. Each agent receives a batch of rows, inserts the batch of rows into a temporary table, and performs a join operation between the temporary table and the actual source or target table. The agent returns the rows resulting from the join operation to the server.

### FIELD OF THE INVENTION

The present invention relates to database comparison tools and, more specifically, to querying a source or target database table for database comparison.

### BACKGROUND

Database comparison tools compare one set of data to another and identify data that is out-of-sync. Database comparison tools allow users to repair any data that is found out-of-sync. The biggest obstacle for database comparison has to do with size. Many database comparison tools cannot handle large tables without crashing or running out of resources. Comparison of large database tables requires fetching many rows from the source and target databases and comparing rows with the same primary key to determine if the rows from the source database match the rows from the target database. This process can consume a significant amount of time and compute resources and require a large amount of data to be transmitted between the databases and a server machine performing the comparison. Thus, there is a need for an efficient technique for fetching and comparing rows of database tables for database comparison.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating an architecture for a database comparison tool in accordance with an illustrative embodiment.

FIG. 2 is a flowchart illustrating operation of a database comparison tool in accordance with an illustrative embodiment.

FIG. 3 is a flowchart illustrating operation of an initial comparison step for a database comparison in accordance with an illustrative embodiment.

FIG. 4 is a block diagram illustrating a row fetch for the initial comparison step in accordance with an illustrative embodiment.

FIG. 5 is a flowchart illustrating operation of a confirmation step for a database comparison in accordance with an illustrative embodiment.

FIG. 6 is a flowchart illustrating operation of a join-based fetch of rows by an agent in accordance with an illustrative embodiment.

FIG. 7 is a block diagram illustrating an agent performing a join-based fetch of potentially out-of-sync rows in accordance with an illustrative embodiment.

FIG. 8 is a block diagram that illustrates a computer system upon which aspects of the illustrative embodiments may be implemented.

FIG. 9 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

The illustrative embodiments provide a database comparison tool that compares a source database to a target database. The database comparison tool performs the comparison in two steps: an initial comparison step and a confirmation step. In the initial comparison step, a server retrieves rows of a table from source and target database tables with a query using an agent. The server compares rows by using a hash value for all non-key columns. The row hash comparison is fast but not accurate; therefore, the resulting rows are flagged as potentially being out-of-sync.

In the confirmation step, the server fetches the potentially out-of-sync rows from the source and target databases and performs a literal value-by-value comparison to determine whether each row was in-flight (the row was out-of-sync in the initial comparison step but has since been updated), in-sync (source row values were applied to the target row by replication or another method), or persistently out-of-sync (the row has not been updated since the initial comparison step took place). In one approach, batches of rows are retrieved by submitting a predicated query for each batch. A predicated query includes a set of one or more predicate conditions, each set identifying a row to retrieve. Specifically, a predicated query is a SELECT query that includes a disjunction of predicate conditions that each identifies a row; each predicate condition can include a conjunction of column specific conditions. Such a SELECT query can become very large depending on the number of conditions (e.g., columns in this case); therefore, the number of rows that can be identified and retrieved by a SELECT query is limited by the maximum size of a SQL query. Furthermore, using SELECT statements for batch retrieval of rows from a table with no index results in table scans, which consume significant time and resources.

In accordance with the illustrative embodiments, the confirmation step is optimized for a table with no index. The agent receives a batch of rows that are flagged as potentially being out-of-sync and inserts the batch of rows into a temporary table. Instead of issuing a predicated query for each batch of rows to retrieve, a join query is issued to the database to perform a join operation between the temporary table and the actual source or target table. The agent returns the rows resulting from the join operation to the server. Thus, a larger number of rows may be retrieved using a single join query in lieu of issuing multiple predicated queries that each requires its own table scan. This join-based fetch approach avoids the multiple table scans per batch and provides a much more efficient technique for fetching rows from a table with no index.

This database comparison tool of the illustrative embodiments decreases the time required for comparison of a table with no indexes, enhances the user experience, and increases confidence of the user in the database comparison tool. Because the row fetch technique is orchestrated and managed completely by the product, the end user does not have to worry about the complexity of the row fetching technique and can concentrate more on the comparison result. Moreover, because this is done on the fly, there are no overhead configurations required by end user, thus making it more transparent to the end user. For smaller tables (rows in the tens of thousands), using a temporary table for a join operation to fetch rows may be overengineering; however, the performance benefits may be realized in all use cases.

### Database Comparison

A database comparison tool compares one set of data to another and identifies data that is out-of-sync. A database comparison tool allows users to repair any data that is found out-of-sync. The database comparison tool of the illustrative embodiments supports high-volume, continuous, heterogenous replication environments where downtime to compare data sets is not an option. By accounting for data that is being replicated while a comparison takes place, the database comparison tool can run concurrently with data transactions and replication, while still producing an accurate comparison report.

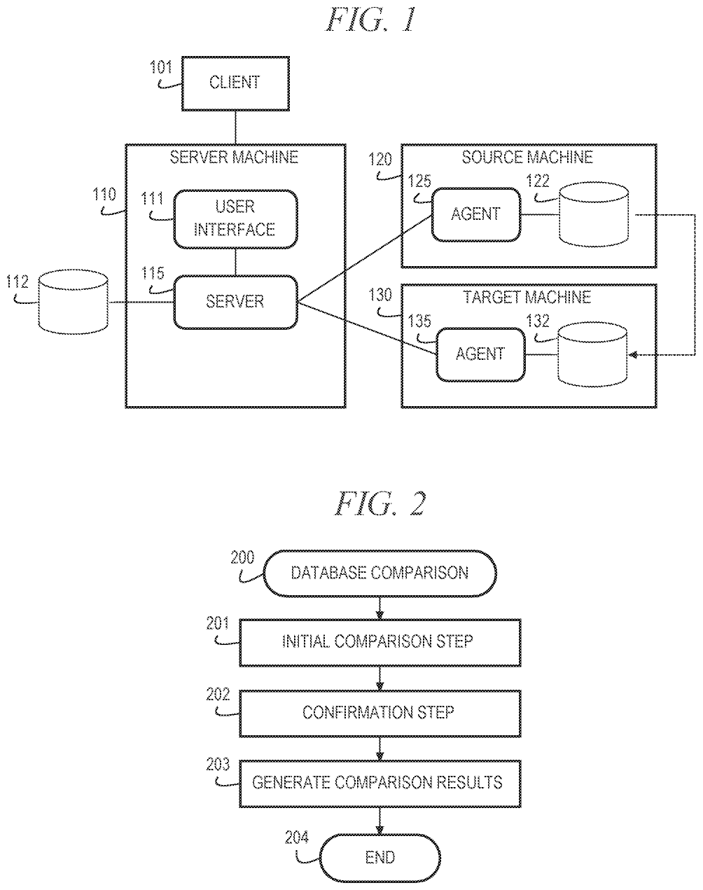

FIG. 1 is a block diagram illustrating an architecture for a database comparison tool in accordance with an illustrative embodiment. Server machine 110 connects to source machine 120 and target machine 130. Source machine 120 manages source database 122, and target machine 130 manages target database 132. In accordance with the embodiment shown in FIG. 1, source database 122 is replicated to target database 132; however, in other embodiments, replication may be bi-directional. Database replication is the process of creating copies of a database and storing them across one or more destinations. Replication improves data availability and accessibility. Every user connected to the system can access copies of the same (presumably up to date) data. Database replication is an ongoing process. If a user accesses and changes data in source database 122, those changes are synced (synchronized or replicated) to target database 132. This ensures that users are always working with the latest and most accurate data.

Ideally, source database 122 and target database 132 will be in sync due to the replication. However, keeping databases and their replica copies consistent across all locations can be a challenge. Poor data governance can lead to replicated databases getting out of sync. With poorly built data pipelines and ineffective use of change data capture, data accuracy and integrity between source database 122 and target database 132 could result in data being out of sync. Data loss can also occur during replication. This can happen if database objects are incorrectly configured or if the primary key used to verify data integrity is malfunctioning or incorrect. With data loss due to database replication, source database 122 and target database 132 become out of sync, and the data is no longer consistent. Therefore, it is important to perform a database comparison to identify data (e.g., database table rows) that are out-of-sync and to allow repair of the out-of-sync data.

The server machine 110 executes server software component 115 and a user interface 111, which may be a command-line interface or a Web-based interface, for example. The user may modify configuration of the server software component 115, initiate a database comparison, review the status and output of comparisons, review out-of-sync data, and repair out-of-sync data via user interface 111 via client 101. The server software component 115 performs the following functions: coordinate execution of database comparison tasks, sort rows (optional), compare data, confirm out-of-sync data, and produce a report for review.

As shown in FIG. 1, source machine 120 executes agent software component 125 (source agent), and target machine 130 executes agent software component 135 (target agent). Each agent 125, 235 may perform the following database-related requests on behalf of server 115: hashing rows for initial comparison, fetching and updating rows to repair out-of-sync data, and returning column-level detail for confirming out-of-sync rows. Server 115 persists database objects and configuration information to repository 112, saving the database objects and configuration information permanently as a user environment.

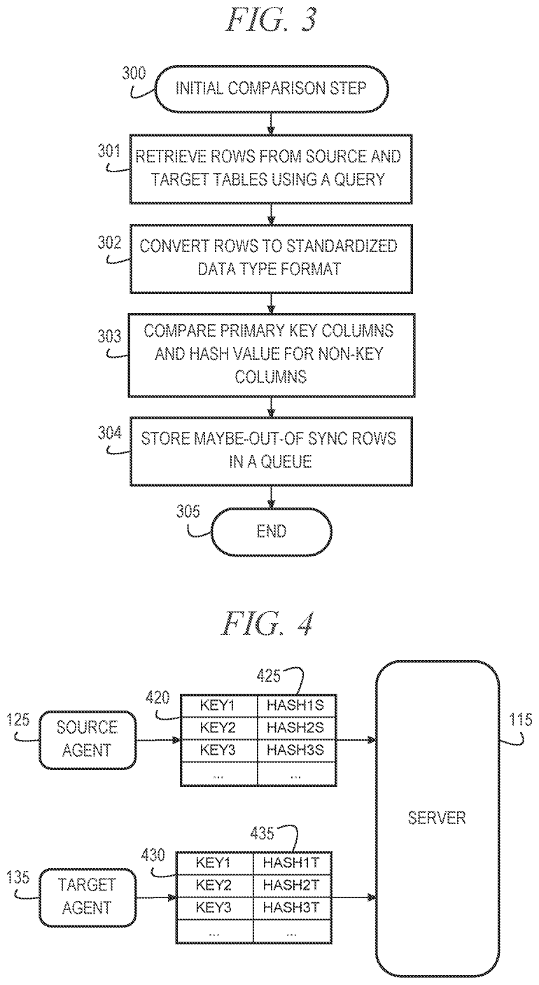

FIG. 2 is a flowchart illustrating operation of a database comparison tool in accordance with an illustrative embodiment. Operation begins when a user initiates a database comparison (block 200). The database comparison tool performs an initial comparison step using a row hash comparison to identify rows that are potentially out of sync (block 201). Operation of the initial comparison step is described in further detail below with reference to FIGS. 3 and 4. Then, the database comparison tool performs a confirmation step to compare the potentially out-of-sync rows from the source database and the target database and identify rows that are out-of-sync based on a literal comparison (block 202). Operation of the confirmation step is described in further detail below with reference to FIGS. 5-7. The database comparison tool then generates comparison results (block 203). The database comparison tool may cause the comparison results to be presented to a user through a user interface and allow the user to review and repair out-of-sync rows in the source database or target database.

### Initial Comparison Step

FIG. 3 is a flowchart illustrating operation of an initial comparison step for a database comparison in accordance with an illustrative embodiment. Operation begins (block 300), and server 115 retrieves rows from source database 122 via source agent 125 and from target database 132 via target agent 135 using a query (block 301). If source database 122 and target database 132 are of different types, the columns are converted to a standardized data type format for accurate comparison (block 302). By default, server 115 compares rows by comparing all columns of the primary key literally (value-for-value) and by using a hash value for all non-key columns (block 303). The unique digital signature that is used to calculate the hash value shrinks the data to be transferred over the network for the comparison. The signature still provides a highly reliable (but not absolute) and efficient mechanism for determining whether two rows contain the same or different column values.

In one embodiment, to ensure that you discover out-of-sync rows, server 115 may be configured to compare non-key rows column-by-column. Full-column comparisons reduce the processing performance in proportion to the number of columns, and they increase network usage. After the initial comparison, server 115 stores rows that appear to be out-of-sync in a maybe out-of-sync (MOOS) queue in memory (block 304), because the comparison is inconclusive. Thereafter, operation ends (block 305). When a replication is working concurrently with a comparison, especially if there is replication latency, rows can appear to be out-of-sync. However, the current data is in flight (somewhere in the replication flow), and replication resynchronizes them.

### Fetching and Sorting Rows by Key Columns

Server 115 relies on a unique identifier to order rows for comparison. By default, server 115 uses the primary key (PK) if one is available. If no primary key is defined, then server 115 uses the smallest unique index. If a table does not have a primary or a unique key, then a user can define an existing index or a set of columns for comparison purposes when defining a compare pair. However, although primary or unique keys can be mapped automatically, user-defined keys must be mapped manually.

There may be use cases where a table has no key columns and there is no unique key or user-defined key. In this case, server 115 may have logic that selects appropriate columns to be key columns to attempt to uniquely define each row. In one embodiment, the appropriate columns are a subset of columns of the table having a predetermined set of datatypes that excludes large object (LOB) type, user defined type (UDT), and extensible markup language (XML) type. In other words, server 115 may select all columns that are not of LOB, UDT, or XML data type to be the key columns for sorting and comparing rows. Server 115 then uses those columns as key columns to fetch rows from source database 122 via source agent 125 and from target database 132 via target agent 135, sort the rows by key columns, create a row hash, and do a hash comparison for rows that map from source to target by the key columns.

Thus, for the case where there is a primary key, a unique key, or a user-defined key, then server 115 will fetch and sort the rows by the primary, unique, or user-defined key and then compare a row hash of each row from the source database table to a row hash of a corresponding row from the target database table. If the row hashes do not match (are not identical), then the row is marked as potentially out-of-sync. This may represent an update to the row in the source that was not replicated to the target or an update to the row in the target that was not replicated to the source.

For the case where there is no primary key, unique key, or user-defined key, server 115 uses all appropriate columns (e.g., columns that are not of type LOB, UDT, or XML) as key columns. Server 115 will then fetch and sort rows by these key columns and compare a row hash of each row from the source database table to a row hash of a corresponding row from the target database table. The keys are concatenated for sorting. If the row hashes do not match (i.e., are not identical), then the row is marked as potentially out-of-sync. This may represent an update to the row in the source that was not replicated to the target or an update to the row in the target that was not replicated to the source.

In the case where there is no primary key, unique key, or user-defined key, and there are no LOB, UDT, or XML columns, then server 115 will use all columns as key columns. Server 115 will then fetch and sort rows by these key columns. However, any row from the source table that does not have a matching row from the target table, or any row from the target table that does not have a matching row from the source table, will be marked as potentially out-of-sync. These potentially out-of-sync rows will appear to be an insert or delete that did not replicate to the other database, even though the rows may not match due to an in-flight update.

FIG. 4 is a block diagram illustrating a row fetch for the initial comparison step in accordance with an illustrative embodiment. As stated above, each agent 125, 135 can perform hashing rows for the initial comparison on behalf of the server. Source agent 125 sends a set of rows 420 including the key and a row hash 425 for each row to server 115. Target agent 135 sends a set of rows 430 including the key and a row hash 435 for each row to server 115. Server 115 then sorts the rows by key and performs a hash compare. For example for the row for KEY1, server 115 compares HASH1S AND HASH1T. If HASH1S matches HASH1T, then the row for KEY1 is marked as in-sync. On the other hand, if HASH2S does not match HASH2T, then the row for KEY2 is marked as potentially out-of-sync.

### Confirmation Step

The confirmation (or confirm-out-of-sync (COOS)) step ensures accurate results by confirming the row status in a changing environment. This step involves predicated queries on the source or target database by using the rows extracted from the MOOS queue. The confirmation step detects the following situations:
in-flight: The row was out-of-sync in the initial comparison step, but it was updated. It is assumed that replication or another mechanism applied the change, but the database comparison tool was unable to confirm that an update subsequent to the initial comparison step resulted in the rows being in-sync. As an example, an in-flight state may indicate that the row was flagged as out-of-sync during the initial comparison step and an update has occurred to the source row that has not been replicated to the target row. In this case, the row is out-of-sync because of an update is in-flight.
in-sync: The source row values were applied to the target row by replication or another method. An in-sync status does not guarantee that the rows are synchronized at any particular moment if the underlying tables are continuously changing, but it does indicate that replication is working. In other words, the row was flagged as out-of-sync during the initial comparison step and the row was determined to be in-sync during the confirmation step; however, other updates could be in-flight because the database comparison is performed against the databases during live replication.
persistently out-of-sync: The row was not updated since the initial comparison step and can be assumed to be out-of-sync. That is, the row was flagged as out-of-sync during the initial comparison step, there is no update that is in-flight, and the row is confirmed to be out-of-sync during the confirmation step.

FIG. 5 is a flowchart illustrating operation of a confirmation step for a database comparison in accordance with an illustrative embodiment. Operation begins (block 500), and server 115 sends rows from the MOOS queue to source agent 125 and target agent 135 (block 501). Server 115 receives rows from source agent 125 and target agent 135 corresponding to the maybe out-of-sync rows (block 502). Server 115 then performs a literal comparison of the source rows and target rows (block 503). Thereafter, operation ends (block 504).

For the confirmation step using a predicated query approach, agent 125, 135 runs a SELECT query for each out-of-sync rows from the initial compare step. As an example, agent 125, 135 may form a SELECT query with an AND for each column and an OR for each column. An example of the syntax for a SELECT query using SQL is as follows:

SELECT “ID”, “NAME” FROM “RCU_USER”.”EMPLOYEE4” X
WHERE
(“ROWID” = ? AND “ID” = ? AND “NAME” = ?) OR (“ROWID” = ?
AND “ID” = ? AND “NAME” = ?) OR (“ROWID” = ? AND “ID” = ?
AND “NAME” = ?)

The example query above is for a batch of three rows having columns for ROWID, ID, and NAME. Using this technique, the batch size is limited by the maximum size for a SQL query.

Furthermore, for a table with no index, each execution of the SELECT query requires a full table scan. Thus, this technique is very slow for a table with no index and all appropriate columns being used as key columns, specifically when the table is very large (e.g., millions of rows) and the number of rows to be fetched is high (e.g., thousands of rows).

### Join-Based Fetch of Rows

The illustrative embodiments replace the predicated query approach with a join-based fetch of rows by the agent 125, 135 using a temporary table for a table with no index column. The agent 125, 135 creates a temporary table with columns that are the same name and type as the key columns used for the initial comparison step. A single database statement may be used to perform the join and retrieve the out-of-sync rows for comparison. The DBMS generates an optimized execution plan for executing the database statement, which would entail no more than one table scan of the source table or the base table, thereby performing the retrieval of out-of-sync rows using less computer resources. Additional optimization may be applied to the executing plan for the database statement.

In some embodiments, each time a batch of potentially out-of-sync rows is received from server 115, the agent 125, 135 inserts the batch of rows into the temporary table and performs the join operation. Server 115 would then wait for the resulting rows to be returned from the agent. In this case, each batch includes a greater number of rows than could be referenced in a predicated SQL query, thus requiring fewer batches and fewer table scans overall. The batch size may be set by the user via user interface 111.

In other embodiments, agent 125, 135 inserts multiple batches of rows into the temporary table before performing a join operation. In this case, server 115 would receive an acknowledgement from the agent and send the next batch of rows. Agent 125, 135 then performs a single join operation, thus requiring only a single table scan. In yet another embodiment, the number of rows to be sent from server 115 to agents 125, 135 is not limited by batch size, and all rows to be compared in the confirmation step can be fetched in a single batch.

FIG. 6 is a flowchart illustrating operation of a join-based fetch of rows by an agent in accordance with an illustrative embodiment. Operation begins when the agent receives a batch of rows to be fetched for the confirmation step from server 115 (block 600). Server 115 and agent 125, 135 communicate serially. Server 115 sends the batch of rows to be fetched by agent 125, 135 and then waits for the agent response before forming the next batch. Agent 125, 135 truncates the temporary table (block 601). Truncate may not be required when doing a join operation with no batching. Agent 125, 135 inserts the rows from the batch of potentially out-of-sync rows into the temporary table (block 602). Agent 125, 135 performs a join of the temporary table and the database table 122, 132 (block 603). In one embodiment, the agent uses an inner hash join to select all the columns from the base table and joining with the columns of the temporary table to fetch the potentially out-of-sync rows. An example of the syntax for a JOIN query is as follows:

SELECT column_name(s)/*
FROM baseTable
INNER JOIN tempTable
ON baseTable.column_name = tempTable.column_name;

Agent 125, 135 then returns rows resulting from the join query to server 125 (block 604). Thereafter, operation ends (block 605).

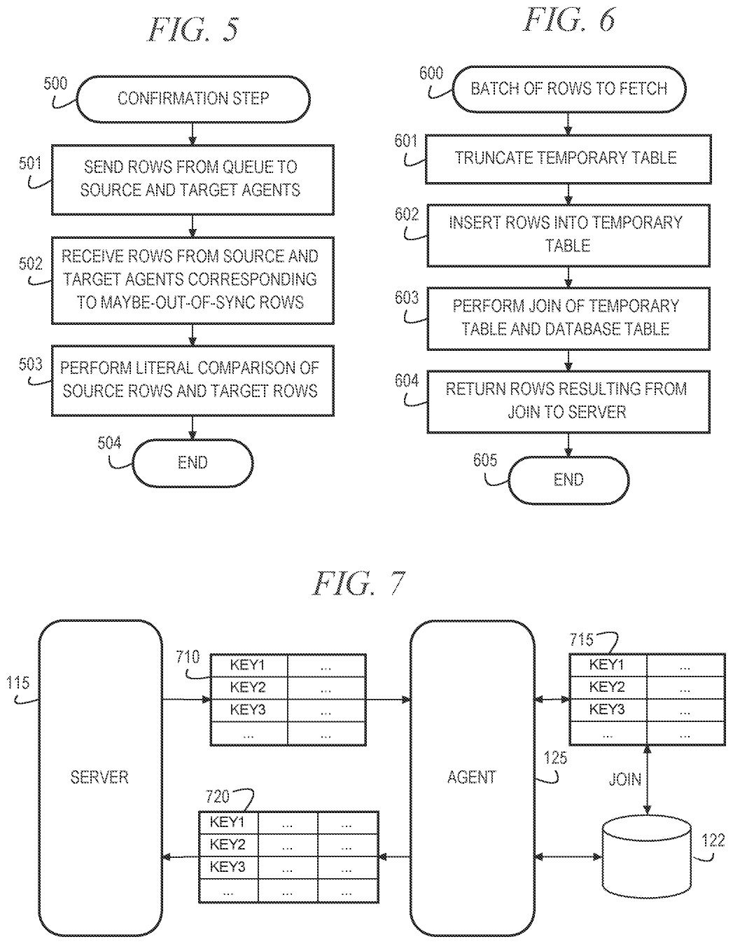

FIG. 7 is a block diagram illustrating an agent performing a join-based fetch of potentially out-of-sync rows in accordance with an illustrative embodiment. In the example shown in FIG. 7, the join-based fetch is performed by the source agent 125; however, the same join-based fetch can also be performed by the target agent 135. Server 115 sends a batch of potentially out-of-sync rows 710 to agent 125. The batch of potentially out-of-sync rows includes the key columns used to perform the initial comparison step. If there is a primary key, unique key, or user-defined key, then the batch of rows potentially out-of-sync rows 710 includes only the primary, unique, or user-defined key. If there is no primary, unique, or user-defined key, then all appropriate columns (e.g., columns not of the LOB, UDT, or XML data type) are included.

Agent 125 inserts the batch of potentially out-of-sync rows 710 into a temporary table 715 and performs an inner hash join of the temporary table 715 and the base table in the source database 122. The inner hash join is a more efficient method of fetching rows and requires a single table scan per join, thus fetching more rows per table scan. Agent 125 then returns the resulting row set 720 including all columns from the source table to server 115.

### Temporary Tables

In accordance with the illustrative embodiments, the database comparison tool with join-based row fetching can be implemented with any database that supports the implementation of a temporary table. In fact, the database comparison tool can be implemented in a heterogeneous replication environment where a source database is replicated to a target database of a different type. In some embodiments, the temporary table is a private temporary table or a global temporary table. A private temporary table is managed at a database session level, and when the database session ends, the private temporary table goes away. A global temporary table would have to be managed beyond the database session. In one embodiment, for a database that does not support temporary tables, the agent can create a table in the database to temporarily store the potentially out-of-sync rows.

If a private temporary table is supported in the database system, then the agent will use a private temporary table. If a private temporary table is not supported, then the agent will use a global temporary table. If the database does not support temporary tables, then the agent will create a physical copy of the base table to use as the temporary table. The type of table that is used as the temporary table affects management of the table but does not affect the join-based fetch of potentially out-of-sync rows.

### Viewing Comparison Results

When a job is completed, a user can view an out-of-sync report, a comparison report, or the files themselves using client 101 via user interface 111. An out-of-sync data report contains out-of-sync comparison results that the user may use for viewing row differences in user interface 111. The user can also use the report to re-compare out-of-sync rows later. To re-compare rows, the user can select run options to execute another confirmation step. The step compares the current state of just those rows and then reports which rows remain out-of-sync after replication or another restorative procedure was applied.

In one embodiment, the out-of-sync data report is stored as XML, written to an XML file and stored to conform to an internal XML schema. One advantage of storing the out-of-sync data report in XML is that it can be easily manipulated by many tools. In its XML form, the out-of-sync data report contains all information, including metadata, that is needed to select rows for resynchronization by external programs.

Each finished job, group, and compare pair generates a comparison report with the following type of information: comparison parameters used, number of rows compared and flagged as out-of-sync, timing of the comparison, performance statistics, and source and target data values. The user can then use the information from the out-of-sync data report to repair out-of-sync rows in either the source database, the target database, or both.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

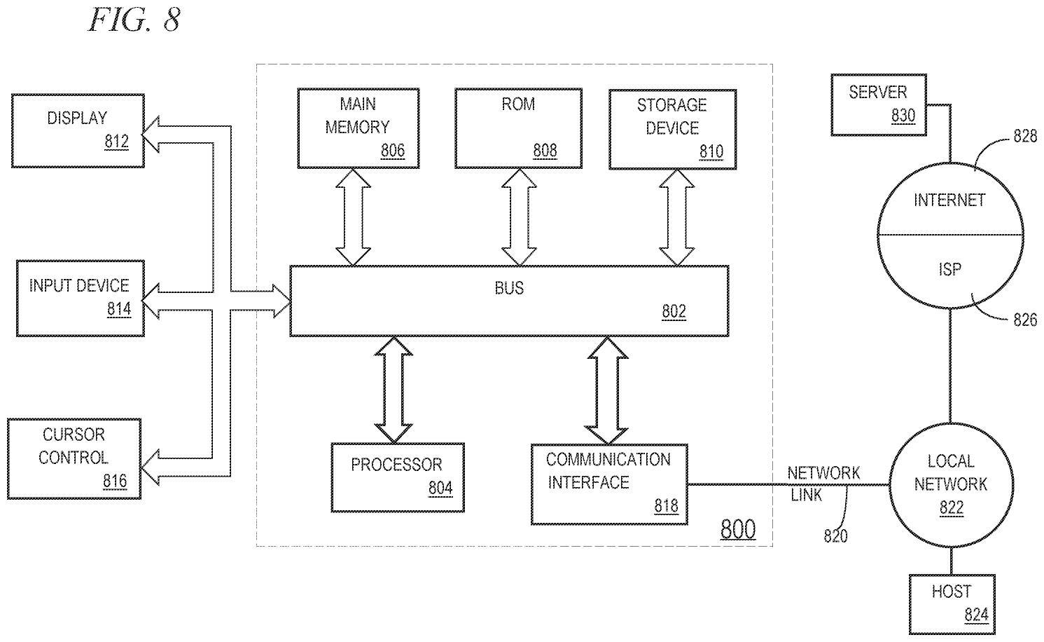

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

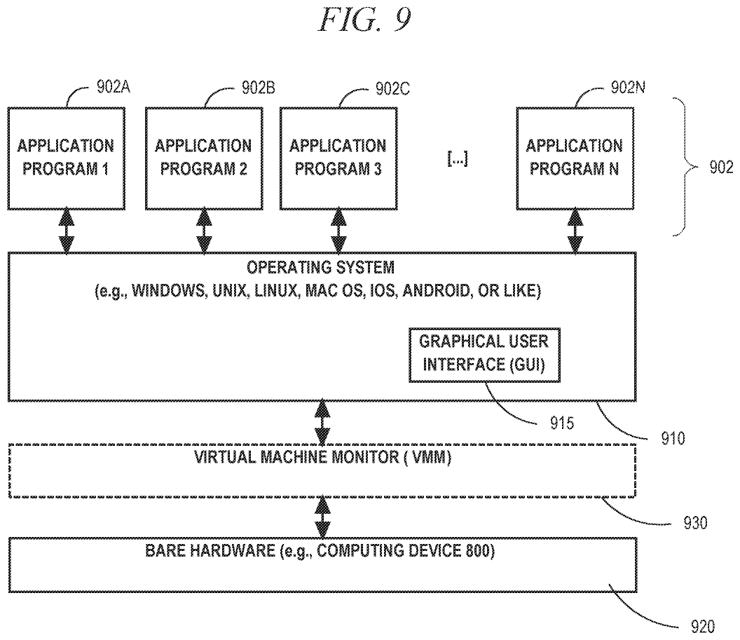

FIG. 9 is a block diagram of a basic software system 900 that may be employed for controlling the operation of computer system 800 upon which aspects of the illustrative embodiments may be implemented. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 900 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
a server performing an initial comparison of rows in a particular table of a first database and rows in a corresponding table of a second database, wherein performing the initial comparison generates a first batch of rows that are flagged as being out of sync to be fetched from the first database and a second batch of rows that are flagged as being out of sync to be fetched from the second database;
the server causing a first agent at the first database to:
insert the first batch of rows into a temporary table;
perform a join operation between the temporary table and the particular table of the first database to form a first result set of rows; and
return the first result set of rows to the server;
the server performing a second comparison of the first result set of rows received from the first agent and a second result set of rows corresponding to the second batch of rows received from a second agent at the second database,
wherein the method is performed by one or more computing devices.

2. The method of claim 1, wherein performing the initial comparison comprises a row hash comparison.

3. The method of claim 2, wherein the first batch of rows of the particular table in the first database comprises one or more key columns of rows that are not identical to a row in the corresponding table in the second database based on the row hash comparison.

4. The method of claim 3, wherein:
the particular table in the first database has no index, and
the one or more key columns are a subset of columns of the particular table having one or more of a predetermined set of datatypes.

5. The method of claim 4, wherein the predetermined set of datatypes excludes large object (LOB) type, user defined type (UDT), and extensible markup language (XML) type.

6. The method of claim 3, wherein:
the particular table in the first database has no index, and
the one or more key columns comprise a key column selected by a user.

7. The method of claim 1, wherein:
the first database is of a first type,
the second database is of a second type that is different from the first type, and
performing the initial comparison comprises converting columns of the particular table in the first database and columns of the corresponding table in the second database to a standardized data type format.

8. The method of claim 1, wherein:
performing the initial comparison generates a plurality of batches of rows that are flagged as being out of sync to be fetched from the first database and a plurality of batches of rows that are flagged as being out of sync to be fetched from the second database, and
performing the second comparison comprises performing a comparison of a plurality of result sets of rows received from the first agent and a plurality of result sets of rows received from the second agent.

9. The method of claim 1, further comprising the server causing results of the second comparison to be presented in a graphical user interface.

10. The method of claim 1, wherein the second database is a replicated copy of the first database.

11. The method of claim 1, wherein the first database is a replicated copy of the second database.

12. The method of claim 1, wherein the temporary table includes a column for each key column of the particular table used to flag the first batch of rows as being out of sync.

13. The method of claim 12, wherein the join operation comprises an inner join operation that selects all columns of the particular table and joins with the columns of the temporary table.

14. The method of claim 1, wherein the join operation comprises a hash join operation.

15. The method of claim 1, wherein the particular table of the first database has no index columns.

16. The method of claim 1, wherein the temporary table comprises a global temporary table or a private temporary table.

17. One or more non-transitory storage media storing instructions which, when executed by one or more computing devices, cause:
a server performing an initial comparison of rows in a particular table of a first database and rows in a corresponding table of a second database, wherein performing the initial comparison generates a first batch of rows that are flagged as being out of sync to be fetched from the first database and a second batch of rows that are flagged as being out of sync to be fetched from the second database;
the server causing a first agent at the first database to:
insert the first batch of rows into a temporary table;
perform a join operation between the temporary table and the particular table of the first database to form a first result set of rows; and
return the first result set of rows to the server;
the server performing a second comparison of the first result set of rows received from the first agent and a second result set of rows corresponding to the second batch of rows received from a second agent at the second database.

18. The one or more non-transitory storage media of claim 17, wherein the particular table of the first database has no index columns.

19. The one or more non-transitory storage media of claim 17, wherein the temporary table includes a column for each key column of the particular table used to flag the first batch of rows as being out of sync and wherein the join operation comprises an inner join operation that selects all columns of the particular table and joins with the columns of the temporary table.

20. The one or more non-transitory storage media of claim 17, wherein the instructions further cause:
